(19) United States
(12) Patent Application Publication
(10) Pub. No.: US 2008/0302274 A1
(43) Pub. Date: Dec. 11, 2008

(54) Hydrophilic coating lacquer

(75) Inventors: INGO NEUBERT, Norderstedt (DE); MAREN KLOSE, Seevetal (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AKTIENGESELLSCHAFT, Hamburg (DE)

(21) Appl. No.: 11/774,061

(22) Filed: Jul. 6, 2007

(30) Foreign Application Priority Data
Jun. 7, 2007 (DE) 10 2007 026 998.8

(51) Int. Cl. C08G 63/00

(52) U.S. Cl. 106/287.25; 106/287.24

(57) ABSTRACT

Coating lacquer in particular for use in biosensors and diagnostic strips composed of
at least one surfactant substance with
   a critical micelle-formation concentration (CMC, 25° C.) of at most 2.3 g/L and
   a surface tension (25° C.) of its 0.1% strength by weight aqueous solution of at most 50 mN/M,
at least one solvent,
at least one binder and also
if appropriate, further additives,
where the surface obtained after drying of the coating lacquer has
   a contact angle with water of at most 30° and
   a surface tension of at least 60 mN/m.

The present invention relates to a hydrophilic coating lacquer which, after drying, permits long lasting rapid spreading or long lasting rapid transport of biological liquids, for example blood, urine, saliva or cell fluid in biosensors or analytical test strips, preferably being applied by a printing process.

In modern medical diagnostics, the number of analytical test strips used, known as diagnostic test strips, and the number of biosensors used, is constantly increasing. These also include what are known as microfluidic devices and lab-on-a-chip applications. Biosensors can, for example, be used on biological liquids firstly to search for pathogens, incompatibilities, DNA activity or enzyme activity, and secondly to determine content of glucose, cholesterol, proteins, ketones, phenylalanine or enzymes.

Detector reactions or reaction cascades take place on the biosensors or test strips. For this, the biological test liquid has to be transported to the reaction site or to various reaction sites. Modem biosensors and test strips are therefore composed of at least one microchannel or microchannel system, through which the test liquid is transported. The height and width of the microchannels are typically from 5 to 1500 μm. Transport within the channels takes place via capillary or centrifugal forces. The results of the detector reactions are mostly read off optically or electrochemically.

Examples that may be mentioned of typical applications are microfluidic devices (e.g. US 2002/0112961 A1, U.S. Pat. No. 6,601,613 B2, U.S. Pat. No. 7,125,711 B2, EP 1 525 916 A1), biosensors (for example DE 102 34 564 A1, U.S. Pat. No. 5,759,364 A1) and blood sugar test strips (for example WO 2005/033698 A1, U.S. Pat. No. 5,997,817 A1). Other examples of applications are DNA microarrays and immunoassays.

In all of these systems, it is important to use capillary geometry and surface properties of the capillary inner wall to control transport of the liquid. A coating can be used to influence surface properties. The use of standard materials with no specific coating is often inappropriate, because of inhomogeneous surface properties and low wettability. A current direction of development in biosensors and test strips is aimed at shortening the test time, and this demands inter alia a shortening of the transport velocity of the biological liquid.

Various investigations on the topics of capillary action and transport of liquids in capillaries can be found in the literature. The capillary pressure and the ascension of a liquid column in a capillary depend on the surface tension of the liquid, the viscosity of the liquid, the angle of wetting and the diameter of the capillary. The following formula is used to determine ascension (equation 1 (eq. 1)):

$$h = \frac{4 * {γ}_{l} * cos θ}{g ( {ϑ}_{l} - {ϑ}_{g} ) * d} \qquad eq . 1$$

h—ascension or depression

γₗ—surface tension of liquid

Θₗ—density of liquid

Θₗ—density of gas (air)

g—acceleration due to gravity

θ—contact angle (angle of wetting, marginal angle)

d—internal diameter of capillary

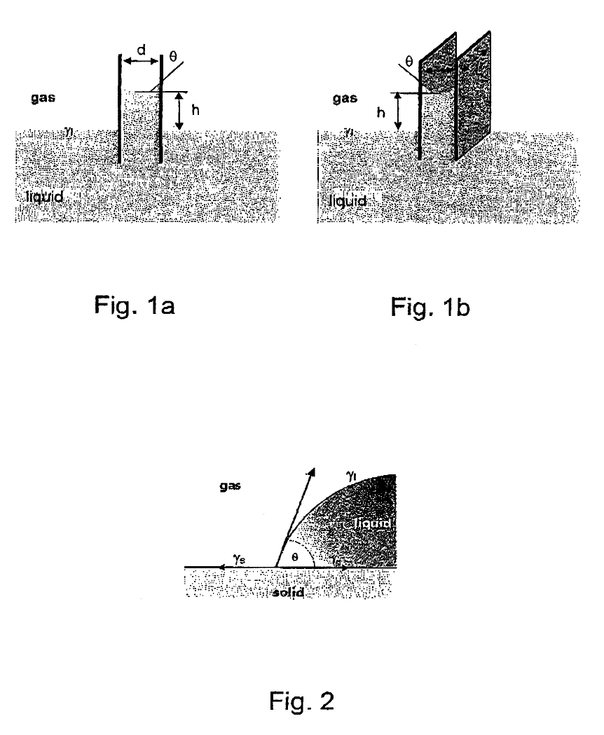

FIG. 1a illustrates equation 1.

If a capillary composed of two parallel plates is considered, where the width of the plates L is significantly greater than the distance d of the plates from one another, equation 1 simplifies to (for s<<L):

$$h \approx \frac{2 * {γ}_{l} * cos θ}{g * {ϑ}_{l} * s} \qquad eq . 2$$

h—ascension or depression

γₗ—surface tension of liquid

Θ₁—density of liquid

g—acceleration due to gravity

θ—contact angle (wetting angle, marginal angle)

s—separation of parallel plates

FIG. 1b illustrates equation 1

From equations 1 and 2, we see that capillary forces increase as capillary diameter or distance between the plates decreases. Flow rate in a capillary can therefore be lowered by enlarging the cross section of a microchannel. Another important parameter affecting flow rate of a given liquid is the surface tension of the inner side of the channel, whereas viscosity is a parameter that cannot be varied for a given liquid.

In the case of a very small angle of wetting between liquid and capillary wall, capillary ascension is found, meaning that the liquid rises in the capillary. For contact angle >90°, capillary depression occurs: the liquid is displaced from the capillary. (W. Bohl “Technische Strömungslehre” [Rheology], 13th revised and extended edition, Vogel Verlag, June 2005, ISBN: 3834330299, page 37 et seq.).

Numerous investigations of surface tension and of the phenomenon of wettability of solids are found in the literature

Young's equation (eq. 3) describes the wetting of a solid by a liquid (in which connection see FIG. 2):

γₗ*cos θ=γₛ−γₛₗ eq. 3

θ—contact angle (angle of wetting, marginal angle)

γₗ—surface tension of liquid

γₛ—surface tension of solid

γₛₗ—interfacial tension between liquid and solid

If the surface tensions of the solid and of the liquid are markedly different, the result is a contact angle θ>90°. The surface of the solid cannot be wetted by the liquid. In the range from 90° to 20°, wetting of the surface of the solid occurs. At contact angles θ<20°, the surface tensions are very similar between liquid and solid, and very good wetting of the surface of the solid by the liquid occurs. For contact angles θ<<20° (θ˜0°) the liquid spreads on the surface of the solid (see “Die Tenside” [Surfactants], Kosswig/Stache, Carl Hanser Verlag, 1993, ISBN 3-446-16201-1, page 23).

The literature describes the use of surfactants, which the person skilled in the art knows as substances active at interfaces, for improvement of wettability. Surfactants are molecules or polymers which are composed of a non-polar/hydrophobic portion (tail) and a polar/hydrophilic group (head). To improve wettability of surfaces, surfactants are added to the aqueous liquid. The surfactant reduces the surface tension of the aqueous liquid at the interfaces (liquid-solid and liquid-gaseous) This effect of improvement of wettability of surfaces is measurable in a reduction of the contact angle and in reduction of the surface tension of the liquid. The person skilled in the art makes a distinction between anionic, cationic, amphoteric and non-ionic surfactants. The hydrophobic tail of surfactants can be composed of linear or branched alkyl, alkylbenzyl, perfluorinated alkyl or siloxane groups. Possible hydrophilic head groups are anionic salts of carboxylic acids, of phosphoric acids, of phosphonic acids, of sulphates, or of sulphonic acids or of succinic esters, or are cationic ammonium salts or non-ionic polyglycosides, polyamines, polyglycol esters, polyglycol ethers, polyglycolamines, polyfunctional alcohols or alcohol ethoxylates (see also Ullmann's Encyclopedia of Industrial Chemistry, Vol. A25, 1994, page 747).

In principle, an increase in surface tension or better wettability of the inner side of the microchannels can lead to an increase in the transport velocity of the biological liquid within the microchannels. The said increase in surface tension with resultant better wettability can be achieved via hydrophilic coatings with polar polymers, such as polyvinylpyrrolidone, polycaprolactam, polyethylene glycol, poly(meth)acrylic acid or polyvinyl alcohol, or with copolymers having appropriate polar functional groups. The wettability or hydrophilic properties of the said coatings are, however, often insufficient for rapid transport of the biological liquids in the microchannels.

Chemical or physical modifications of the surfaces are likewise inappropriate. Standard methods for this are corona treatment and flame treatment. These treatments are not stable over time. The markedly increased surface energy decreases to the initial value after as little as a few days. Chemical modification can be achieved via etching of the surface with a strong acid. For example, oxidizing acids are used for surface etching of technical foils, examples being chromic-sulphuric acid mixture or potassium permanganate in conjunction with sulphuric acid Polyester foils (PET) are surface-hydrolysed in industry, usually via chemical treatment with, for example, trichloroacetic acid or potassium hydroxide, as disclosed in WO2005/111606 A1. Wettability and surface tension are stable in these methods even after storage. However, the wetting properties are inhomogeneous across the surface.

The surface can moreover be modified via plasma treatment. To this end, the surface is treated with a plasma in vacuo. Introduction of gases or organic substances can adjust the surface properties as desired. For example, either hydrophilic or hydrophobic layers can be produced on the surface. U.S. Pat. No. 6,955,738 B2 describes the application of the said process. WO 01/02093 A2 describes the use of a foil with a microstructured surface for the control of liquid transport.

DE 102 34 564 A1 describes a biosensor which is composed of a planar sensor or test strip and of a compartmented reaction- and test-chamber superstructure, produced via embossing of a PVC foil. For transport of the biological liquid, the channel that receives the specimen, and the measurement chamber, are equipped with a hydrophilic web or a surfactant. A very similar electrochemical sensor is described in U.S. Pat. No. 5,759,364 A1. The sensor is composed of a printed base plate and of an embossed top foil composed of PET or polycarbonate. The test chamber here has a coating of a polyurethane ionomer for accelerating liquid transport.

A number of publications mention the use of hydrophilic materials such as webs (DE 30 21 166 A1), membranes (DE 198 49 008 A1) and foils (EP 1 358 896 A1, WO 01/67099 A1), but without any more detailed characterization of the hydrophilic coatings.

DE 198 15 684 A1 describes an analytical aid composed of a capillary-action zone, a stamped-out piece of adhesive tape, and a capillary-action top foil. The capillary-action top foil has hydrophilic surface properties, which are achieved by aluminium-metallization of the top foil and subsequent oxidation.

US 2005/0084681 A1 discloses a surface with a hydrophilic coating. This coating is composed of a surfactant, preferably a non-ionic alcohol ethoxylated, and a stabilizer, preferably an alkylbenzenesulphonate,

EP 1 647 568 A1 describes what is known as an antifog coating. This coating is applied to a polyester foil and serves to avoid water droplet formation in food packaging. The antifog coating involves a hydrophilic coating composed of an anionic surfactant, a polyvinylpyrrolidone as matrix polymer, and water.

There are nowadays commercially available foils with full-surface hydrophilic coating for application in medical diagnostic strips, examples being the products 9962 and 9971 from 3M Inc., their use being indicated in US 2002/0110486 A1 and EP 1 394 535 A1, and ARflow® 90128 and ARflow® 90469 from Adhesives Research Inc., their use being indicated in U.S. Pat. No. 5,997,817 A1.

The literature likewise discloses some examples in which hydrophilic and hydrophobic regions are utilized specifically for control of liquid transport. In U.S. Pat. No. 6,601,613 B2, capillary geometry is used to control liquid transport. Another possibility mentioned, but not described in any further detail, is the use of surfactants or hydrophobic polymers.

U.S. Pat. No. 6,969,166 B2 describes a modified surface with two different contact angles. The modification is achieved via digital print (inkjet print) of hydrophobic polymers based on fluorine polymers or on silicone polymers, and, respectively, of hydrophilic polymers. The static contact angles given in the examples for the hydrophilic coating are 75°.

As the prior art indicates, surfactant hydrophilic coatings are needed to achieve rapid transport of biological test liquids in a test channel. As a function of the raw materials used, there are considerable disadvantages found here in relation to ageing resistance and mutual compatibility of raw materials. These interactions are described inter alia by Popescu et al. in “Untersuchung über die Wechselwirkung Polymer—Tensid” [Study of polymer-surfactant interaction] in Colloid & Polymer Science, Springer Verlag, Vol. 250, 1972, page 303 et seq.

It is an object of the present invention to provide a coating lacquer which has hydrophilic properties after removal of the solvent. The dried coating lacquer meets the requirements for use in biosensors and diagnostic test strips and is appropriate for the construction of the same and specifically permits transport of the biological liquid in the test channels. A further intention here is to ensure that the properties and specifically the wetting and transport properties of the surface resulting from drying of the coating lacquer are retained even after a long storage time.

This object is achieved via a coating lacquer as set out in the main claim- Advantageous embodiments of the inventive subject matter are provided by the subclaims. The invention also encompasses the possible use of the inventive coating lacquer after drying of the same, inter alia in medical sensors or diagnostic strips for investigating biological liquids.

Accordingly, the invention provides a coating lacquer in particular for use in biosensors and diagnostic strips composed of

at least one surfactant substance with
a critical micelle-formation concentration (CMC, 25° C.) of at most 2.3 g/L and
a surface tension (25° C.) of its 0.1% strength by weight aqueous solution of at most 50 mN/m,

at least one solvent,

at least one binder and also

if appropriate, further additives,

where the surface obtained after drying of the coating lacquer has
a contact angle with water of at most 30° C. and
a surface tension of at least 60 mN/m.

In one advantageous embodiment of the invention, the surfactant substance has a critical micelle-formation concentration (CMC, 25° C.) of at most 1.5 g/L and/or a surface tension of its 0.1% strength by weight aqueous solution of at most 45 mN/m.

The surface-active substances used, known to the person skilled in the art as surfactants, can comprise compounds composed of linear or branched alkyl, alkylbenzyl, perfluorinated alkyl or siloxane groups having hydrophilic head groups, e.g. anionic salts of carboxylic acids, phosphoric acids, phosphonic acids, sulphates, sulphonic acids or sulphosuccinic acid, e.g. cationic ammonium salts or e.g. non-ionic polyglycosides, polyamines, polyglycol esters, polyglycol ethers, polyglycolamines, polyfunctional alcohols or alcohol ethoxylates. This selection is a list of examples and does not restrict the inventive concept to the surfactants mentioned.

When selecting the surfactant, a necessary factor is a low critical micelle-formation concentration (CMC) of at most 2.3 g/L, preferably of at most 1.5 g/L, and a low surface tension of its 0.1% strength by weight aqueous solution of at most 50 mN/m, preferably of at most 45 mN/m, in order to permit rapid transport of the biological test liquid. Both the CMC and the surface tension are a measure of the activity or effectiveness of surfactants.

Surprisingly, these surfactants particularly feature excellent ageing resistance.

The following suitable surfactants may be mentioned by way of example:
nonionic fatty alcohol ethoxylated surfactants, for example Tego Surten® W111 from Degussa AG or Triton® X-100 and Tergitol® 15-S from Dow Chemicals Inc (CMC 1.0 g/L, surface tension of its 0.1% strength by weight aqueous solution 30 MN/m)
nonionic fluorosurfactants, for example Fluorad° FC-4430 and FC4432 from 3M Inc., Zonyl® FSO-100 from DuPont Inc. and Licowet® F 40 from Clariant AG (CMC 0.1 g/L, surface tension of its 0.1% strength by weight aqueous solution 20 mN/m)
nonionic silicone surfactants for example Q2-5211 and Sylgard® 309 from Dow Corning Inc. Lambent® 703 from Lambent Technologie Inc. and Tegopren® 5840 from Degussa AG (CMC 0.2 g/L, surface tension of its 0.1% strength by weight aqueous solution 25 mN/m)
ionic sulphosuccinic salts, for example Lutensit® A-BO from BASF AG, Aerosol® OT-NV from Cytec Industries Inc. or Rewopol® SB DO 75 from Goldschmidt GmbH (CMC 1.5 g/L, surface tension of its 0.1% strength by weight aqueous solution 40 mN/m)

The surfactant present in the inventive coating lacquer preferably comprises an anionic surfactant and particularly preferably sulphosuccinic salts.

The inventive coating lacquer comprises at least one solvent which is removed after application of the material, giving a solid, dry coating which is not transferable via contact with solid articles, for example rolls or plastics materials, Solvents used comprise water, alcohols, ethanol, or higher-boiling-point alcohols, such as n-butanol or ethoxyethanol, ketones, such as butanone, esters, such as ethyl acetate, alkanes, such as hexane, toluene, or a mixture composed of the abovementioned solvents. Polar organic solvents are preferably used, examples being alcohols and particularly water. Among the alcohols, preference is further given to ethanol, isopropanol or butanol.

The inventive coating lacquer comprises at least one binder. The binder serves to adjust the viscosity of the coating lacquer. Appropriate adjustment of viscosity is necessary as a function of the coating process used. The table below lists examples of typical viscosities for different coating processes.

| | Required |
|---|---|
| | dynamic viscosity of coating |
| | lacquer for each coating process |
| Coating process | [mPa * s] |
| Doctor coating | 500-40 000 |
| Halftone-roll application | 1-5000 |
| Spray coating | 1-100 |
| Meyer bar coating | 20-1000 |
| Flexographic printing | 50-500 |
| Inkjet printing | 1-30 |
| Screen printing | 500-50 000 |
| Offset printing | 40 000-100 000 |
| Intaglio printing | 50-200 |

Binders that can be used for the inventive coating lacquer are any of the foil-forming binders known from the printing ink industry.

Binders preferably used are polymers or copolymers having carboxy, carboxylate, amine, ammonium, amide or alcohol functionalities, and particularly preferably appropriate water-soluble polymers or copolymers.

By way of non-restricting example, suitable binders that may be mentioned are homo- or copolymers, such as polyvinylpyrrolidone, polyvinyl butyral, polyester, polyacrylate, poly(meth)acrylic acid, polyvinyl acetate, partially hydrolysed polyvinyl acetate, polyvinyl alcohol, poly(meth)acrylamide, polyamide, polyethylene glycol, polypropylene glycol, cellulose derivatives. The polymers mentioned can also be used in the form of dispersions.

In one preferred version of the inventive coating lacquer, the binder used comprises a polyvinyl alcohol. Polyvinyl alcohols are prepared from polyvinyl acetate via hydrolysis of the acetate functionality. The properties of the polyvinyl alcohols can be controlled firstly by way of the molecular weight of the polymer and secondly by way of the degree of hydrolysis. It is preferable to use a polyvinyl alcohol whose degree of hydrolysis is >85 mol %, particularly preferably >95 mol % By way of example of this class of polymer, mention may be made of Mowiol® from Kuraray or Polyviol® from Wacker Chemie GmbH.

In another preferred version of the inventive coating lacquer, a polyvinyl butyral is used as binder. Polyvinyl butyral is obtained from polyvinyl alcohol via esterification with n-butylaldehyde. Its properties are determined via molecular weight, degree of hydrolysis, and degree of acetalization. It is preferable to use a polyvinyl butyral whose vinyl acetal content is >75% by weight, whose vinyl acetate content is <5% by weight, and whose vinyl alcohol content is from 15 to 30% by weight. By way of example of this class of polymer, mention may be made of Mowital® from Kuraray or Pioloform® from Wacker Chemie GmbH.

In another preferred version of the inventive coating lacquer, the binder used comprises a polyester resin or a maleate resin having free carboxy and hydroxy groups. In order to achieve water-solubility, the polyester resin is neutralized with an ammonia solution or with an amine. An example of this type of resin is Rokrapol® 7160 or Erkamar® VP 4760 from Robert Kraemer GmbH.

In another preferred version of the inventive coating lacquer, the binder used comprises a cellulose derivative. Carboxymethylcellulose and cellulose acetate are particularly suitable for use here.

The coating lacquer can moreover likewise comprise organic dyes, fluorescent dyes, inorganic pigments, antioxidants and/or fillers (in which connection, see “Plastics Additives Handbook”, Chapter on “Antioxidants”, “Colorants”, “Fillers”, Carl Hanser Verlag, 5th Edition).

However, these additives are not absolutely necessary, and the inventive coating lacquer meets all of the requirements, even without further additives.

In one preferred version, the dynamic viscosity of the inventive coating lacquer is from 50 to 500 mPa*s, prior to drying.

The surface obtained after drying of the coating lacquer advantageously has a contact angle with water of at most 23° and a surface tension of at least 65 mN/m.

The aqueous-test-liquid transport velocity exhibited by the coating or, respectively, the coating lacquer, after it has been dried, is advantageously at least 20 mm/s and preferably at least 40 mm/s. The coating features very good storage stability. This is evident in that the transport velocity decreases only by at most 20% and advantageously by at most 10% of the initial value even after storage for 10 weeks at 70° C.

Substrate materials which are conventional and familiar to the person skilled in the art can be coated over the entire surface or else partially with the inventive coating lacquer, examples being foils composed of polyethylene, polypropylene, polypropylene, polyvinyl chloride, polyester, and particularly preferably polyethylene terephthalate (PET). Monofoils or coextruded or laminated foils can be involved here, these being stretched, or monoaxially or biaxially oriented. The surface of the foils can have been microstructured via suitable processes, for example embossing or etching, or lasers.

It is also possible to use laminates, nonwovens, textiles or membranes as substrate. These lists are given by way of example and are not comprehensive.

The substrate materials can have been pretreated chemically or physically by the standard methods to improve anchoring of the coating, and corona treatment or flame treatment may be mentioned by way of example. Priming of the substrate material is likewise possible in order to promote adhesion, for example using PVC, PVDC, thermo-plastic polyester copolymers, or polyurethanes. The anchoring of printing inks is usually checked by an anchoring test as described under test methods.

The thickness of the substrate material is from 12 to 350 μm and preferably from 50 to 150 μm.

The conventional coating processes can be used for application, examples being spray coating, halftone-roll application. Meyer bar coating, multiroll application coating or printing processes. Particular preference is given to application by means of a printing process, such as screen printing, flexographic printing, digital printing, inkjet printing, or condensation coating. Parameters to be considered during selection of the printing process and of the printing lacquer are viscosity, printing accuracy, quality of the printing surface and printing speed. Screen printing, digital printing and inkjet printing are printing processes that mainly produce discrete points in a grid. This can be used to control the surface tension of the regions via the separation and size of the individual points in the grid. However, the preferred method consists in application in the form of a coherent film. Particular preference is given to application of the inventive coating lacquer partially and by means of a printing process, particularly preferably by flexographic printing.

The inventive dried coating lacquer can advantageously be used in medical applications, for example in diagnostic strips, biosensors, point-of-care devices or microfluidic devices, by means of which biological liquids are investigated.

A particularly suitable application takes place in biosensors or analytical test strips, where the arrangement of the coating is such that the coated substrate material forms one wall of a transport channel or of a reaction channel.

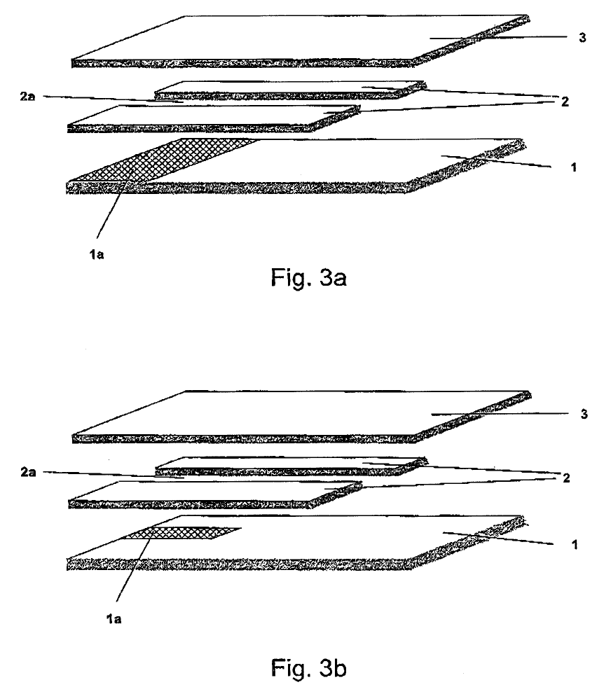

FIGS. 3a and 3b show an example of a structure of a diagnostic strip with a micro-channel 2a, which in this case is formed via a stamped-out section of a double-sided pressure-sensitive adhesive tape 2. However, the microchannel 2a can also be produced via other processes, for example microembossing, injection moulding, laser processes, lithographic processes or sandblasting. The microchannel 2a formed from the pressure-sensitive adhesive tape 2 has been adhesive-bonded on one side to the base foil 3. This base foil 3 thus forms one wall of the microchannel and can also have functional layers, for example electrical conductor tracks or layers having detector reagents or having enzymes. A foil 1, coated at least partially with the inventive coating lacquer 1a, acts as a further wall sealing the microchannel 2a, and the coating here faces towards the inner side of the microchannel. The location here of the coating 1a, which has been applied, for example, in the form of a strip as in FIG. 3a or partially as in FIG. 3b, is at the opening of the microchannel 2a, in order to allow liquid transport into the channel to begin.

Surprisingly, use of the inventive coating lacquer, after it has been dried, as topcoat or as a wall of a transport channel or of a reaction channel in biosensors or in analytical test strips causes very effective and dependable transport of the test liquid.

It is surprising to the person skilled in the art that liquid transport can be considerably accelerated in a channel as shown in FIG. 3a via the coating with the inventive coating lacquer. The coating features excellent ageing resistance. A suitable process, for example a printing process, can be used to apply the coating lacquer with very great precision to the site at which rapid liquid transport is needed (FIG. 3b). It is particularly surprising and not foreseeable that the binder used does not either reduce the activity of the surfactant or impair ageing resistance or affect the detector reaction on the test strips.

### Test Methods

### Surface Tension and Contact Angle Measurement

Contact angle with water and surface tension on solid surfaces are measured to EN 828:1997 by a G2/G402 device from Krüss GmbH. Surface tension is determined by the Owens-Wendt-Rabel & Kaeble method the contact angle has been measured using deionized water and diiodomethane. In each case, the values are obtained by taking the average of four measured values.

### Static Surface Tension (Liquid) and CMC

Surface tension of aqueous liquids is measured by the ring method (du Nouy) to DIN EN 14210 using the K100 Tensiometer from Krüss GmbH at 20° C.

Critical micelle-formation concentration (CMC) is determined (DIN 53914) by way of automatic metering of the surfactant using the K100 Tensiometer from Krüss GmbH and then evaluating the concentration/surface behaviour,

### Dynamic Viscosity Measurement

The viscosity of the coating lacquer is measured using a Rheometrix DSR 200N at a shear rate of 10 1/s using a ball-and-plate system with a diameter of 50 mm.

### Channel Test (Function Test)

To assess the transport behaviour of an aqueous test liquid, a capillary test is carried out. For this, a stamped-out section of a double-sided adhesive tape whose thickness is 80 μm (tesa® 4980, a double-sided pressure-sensitive adhesive tape composed of a 12 μm PET substrate foil coated on both sides with an acrylate adhesive mass (in each case 34 g/m²), product thickness 80 μm) is laminated to a PET foil of thickness 100 μm (Hostaphan® RN 100 from Mitsubishi Polyesterfilm GmbH). The stamped-out section forms a test channel whose width is 1 mm and whose length is 3 cm. The channel is open at both ends. This test channel is then covered with the foil to be tested, so that the surface to be tested forms one wall of the channel. The regions here are positioned so that the hydrophilic region is at the margin of the channel and the hydrophobic region is in the interior of the channel The dimensions of the channel or the capillary are; height 75 μm and width 1 mm (see FIG. 3a).

The test channel is held with the aperture at whose end the hydrophilic region has been positioned in a test liquid composed of deionized water and 1% by weight of naphthol red. Transport of the test liquid in the hydrophilic region is observed by means of a video camera and transport velocity is determined. The channel test is also to be carried out after the channels or foils to be tested have been stored at 23° C., 40° C. and 70° C., in order to check ageing resistance and storage stability.

Biological liquids, such as blood, are likewise used as test liquid, but these are less appropriate, since they are subject to variations in properties. For example, the viscosity of blood varies very markedly. The viscosity of blood depends on the haematocrit value.

### Anchoring

For determination of anchoring of the coating, after application and drying, to a substrate material, a single-sided stationery adhesive tape such as tesa 4140 (23 g/m² of acylate dispersion adhesive mass, 35 μm BOPP substrate foil) is adhesive-bonded over the coating and subjected to manual pressure, in what is known as the tesa anchoring test. The adhesive tape is then peeled in a single movement. An assessment is now made as to whether the coating has adequate anchoring to the substrate or whether the coating is peeled from the substrate by the adhesive tape to some extent or over the entire surface.

A number of examples will be used below for further illustration of the invention, but are not intended to restrict the invention unnecessarily.

### EXAMPLES

| Raw material | Producer | Type of raw material | Properties |
|---|---|---|---|
| Lutensit A-BO | BASF AG | Na diisoctylsulphosuccinate | Surfactant |
| | | | CMC 1.5 g/L |
| | | | 40 mN/m |
| Rewopol SB DO | Degussa AG | Na diisoctylsulphosuccinate | Surfactant |
| 75 | | | CMC 1.5 g/L |
| | | | 40 mN/m |
| Tegopren W 5840 | Degussa AG | Siloxane ethoxylates | Surfactant |
| | | | CMC 0.05 g/L |
| | | | 23 mN/m |
| Mowiol 4-98 | Kuraray | Polyvinyl alcohol | 98.4% vinyl alcohol |
| | Specialities | | 1.5% vinyl acetate |
| Piloform BM 18 | Wacker Chemie | Polyvinyl butyral | 18% vinyl alcohol |
| | | | 2% vinyl acetate |
| | | | 80% vinyl acetal |
| Luvitec K60 | BASF AG | Polyvinylpyrrolidone | K value 60* |
| NeoRez R650 | Neoresins Inc. | PU primer | |

*K value is measured in 1% strength by weight solution in toluene at 25° C. (DIN 53 726)

### Inventive Example 1

10 kg of Mowiol 4-98 and 0.3 kg of Rewopol SB DO 75 are dissolved in 60 kg of water, with continuous stirring. The viscosity of the resultant coating lacquer is 130 mPa*s. The coating lacquer is now printed on a Nilpeter printing machine by flexographic printing onto a corona-pretreated PET foil (Hostaphan® RN 100 from Mitsubishi Polyesterfilm GmbH) and dried by means of IR radiation.

The coating lacquer can be transferred very effectively to the PET foil by the printing process. The coating exhibits very good wetting properties and exhibits high velocity during transport of the aqueous test liquid in the test channel. The transport velocity slows only by 5% after storage of the test strips at 70° C. for 10 weeks.

### Inventive Example 2

The coating lacquer from Example 1 is printed as in Inventive Example 1 onto a PET foil and dried. However, the PET foil was coated in advance with NeoRez R650 primer. The wetting properties exhibited by the hydrophilic coatings are as good as in Inventive Example 1, and it exhibits similarly high transport velocity of the aqueous test liquid in the test channel. This version features very good anchoring of the coating to the PET foil.

### Inventive Example 3

4 kg of Mowiol 4-98 and 0.2 kg of Tegopren W 5840 are dissolved in 60 kg of water, with continuous stirring. The viscosity of the resultant coating lacquer is 27 mPa*s. The coating lacquer is printed by inkjet printing onto a PET foil (Hostaphan® RN 100 from Mitsubishi Polyesterfilm GmbH) coated with NeoRez R650, and dried by means of IR radiation.

The coating lacquer can be applied very effectively to the foil by inkjet printing. Wetting properties and transport velocity of the coating are very good. After storage, the transport velocity value falls back to 65% of the initial value.

### Inventive Example 4

12 kg of Piloform BM 18 and 0.3 kg of Lutensit A-BO are dissolved in 60 kg of water, with continuous stirring. The viscosity of the resultant coating lacquer is 180 mPa*s. The coating lacquer is now printed onto a corona-pretreated PET foil (Hostaphan® RN 100 from Mitsubishi Polyesterfilm GmbH) on a Nilpeter printing machine by flexographic printing, and dried by means of IR radiation.

The coating likewise exhibits very good wetting properties and high transport velocity of the aqueous test liquid in the test channel. This version features very good anchoring of the coating to the PET foil. The properties likewise have good ageing resistance.

| | | Inventive | Inventive | Inventive | Inventive |
|---|---|---|---|---|---|
| | Unit | Example 1 | Example 2 | Example 3 | Example 4 |
| Contact angle | ° | 20 | 19 | 5 | 23 |
| with water | | | | | |
| Surface | mN/m | 68 | 69 | 71 | 65 |
| tension | | | | | |
| Velocity in | mm/s | 56 | 56 | 58 | 53 |
| channel test | | | | | |
| Channel test | mm/s | 53 | 54 | 32 | 50 |
| after storage* | | (−5%) | (−4%) | (−45%) | (−6%) |
| Anchoring of | | ∘ | ++ | ++ | ++ |
| coating | | | | | |

*10 weeks at 70° C.;
−− poor,
∘ moderate,
++ very good

### COMPARATIVE EXAMPLES

### Comparative Example 1

10 kg of Mowiol 4-98 are dissolved in 60 kg of water, with continuous stirring. The viscosity of the resultant coating lacquer is 130 mPa*s. The coating lacquer is now printed onto a corona-pretreated PET foil (Hostaphan® RN 100 from Mitsubishi Polyesterfilm GmbH) on a Nilpeter printing machine by flexographic printing, and dried by means of IR radiation.

The coating exhibits markedly poorer properties of wetting and of transport. The channel test shows that the liquid is not transported into the channel.

### Comparative Example 2

0.3 kg of Rewopol SB DO 75 are dissolved in 60 kg of water, with continuous stirring. The viscosity of the resultant coating lacquer is 1 mPa*s. An attempt is made to print the coating lacquer onto a corona-pretreated PET foil (Hostaphan® RN 100 from Mitsubishi Polyesterfilm GmbH) by flexographic printing. Printing is impossible, since the viscosity of the solution is too low Furthermore, it is impossible to obtain a coherent film with the coating. No measurements can be carried out on the coating.

### Comparative Example 3

8 kg of Luvitec K60 and 0.2 kg of Lutensit A-BO are dissolved in 60 kg of water, with continuous stirring. The viscosity of the resultant coating lacquer is 110 mPa*s. The coating lacquer is now printed onto a corona-pretreated PET foil (Hostaphan® RN 100 from Mitsubishi Polyesterfilm GmbH) on a Nilpeter printing machine by flexographic printing, and dried by means of IR radiation.

The coating exhibits markedly poorer properties of wetting and of transport. Liquid transport in the channel test is very inhomogeneous and varies over a wide range. No liquid transport takes place in 50% of the tests.

| | | Comparative | Comparative | Comparative |
|---|---|---|---|---|
| | Unit | Example 1 | Example 2 | Example 3 |
| Contact angle with | ° | 37 | − | 33 |
| water | | | | |
| Surface tension | mN/m | 56 | − | 59 |
| Velocity in channel | mm/s | − | − | 0-10 |
| test | | | | |
| Channel test after | mm/s | − | − | − |
| storage* | | | | |
| Anchoring of | | ∘ | − | ++ |
| coating | | | | |

*10 weeks at 70° C.;
−− poor,
∘ moderate,
++ very good

1. Coating lacquer composed of at least on surfactant substance with
a critical micelle-formation concentration (CMC, 25° C.) of at most 2.3 g/L and
a surface tension (25° C.) of its 0.1% strength by weight aqueous solution of at most 50 mN/m,
at least one solvent,
at least on binder and also
further additives,
where the surface obtained after drying of the coating lacquer has
a contact angle with water of at most 30° C. and
a surface tension of at least 60 mN/m.

2. Coating lacquer according to claim 1, the surfactant substance has a critical micelle-formation concentration (CMC, 25°) of at most 1.5 g/L and/or a surface tension of its 0.1% strength by weight aqueous solution of at most 45 mN/m.

3. Coating lacquer according to claim 1 surfactant substance is an anionic surfactant.

4. Coating lacquer according to claim 1, wherein solvents used comprise at least one polar solvent.

5. Coating lacquer according to claim 1, wherein binders used comprise at least one polymer or one copolymer having carboxy, carboxylate, amine, ammonium, amide or alcohol functionalities.

6. Coating lacquer according to claim 1, wherein the binder has been selected from the group of polyvinyl alcohol, polyvinyl butyral, polyester resin, maleate resin or cellulose derivative.

7. Coating lacquer according to claim 1, wherein the coating lacquer has a viscosity of from 50 to 500 mPa*s, prior to drying.

8. Coating lacquer according to claim 1, wherein the surface obtained after drying of the coating lacquer has
a contact angle with water of at most 23° and
a surface tension of at least 65 mN/m.

9. Coating lacquer according to claim 1, wherein the transport velocity of an aqueous test liquid (deionized water and 1% by weight of naphthol red) in a channel (75 μm×1 mm) in which the dried coating lacquer forms a wall of the channel amounts to at least 20 mm/s.

10. Coating lacquer according to claim 1, wherein the transport velocity of an aqueous test liquid (deionized water and 1% by weight of naphthol red) in a channel (75 μm×1 mm) in which the dried coating lacquer forms a wall of the channel slows by at most 20% of the initial value after storage for 10 weeks at 70° C.

11. Coating lacquer according to claim 1, wherein the coating lacquer is applied by means of a printing process to a substrate material.

12. Diagnostic strips, biosenors, point-or care devices or microfluidic devices comprising dried coating lacquer according to claim 1.

13. Biosensors or analytical test strips comprising a dried coating lacquer according to claim 1, where the arrangement of the material is such that the coating at least partially forms at least one wall of a transport channel or reaction channel.
